(19) United States
(12) Patent Application Publication
(10) Pub. No.: US 2015/0247983 A1
(43) Pub. Date: Sep. 3, 2015

(54) OPTICAL CONNECTOR FERRULE

(71) Applicant: SUMITOMO ELECTRIC INDUSTRIES, LTD., Osaka (JP)

(72) Inventors: Masaki OHMURA, Yokohama-shi (JP); Takayuki NAKAMURA, Yokohama-shi (JP); Tomomi SANO, Yokohama-shi (JP)

(21) Appl. No.: 14/632,102

(22) Filed: Feb. 26, 2015

(30) Foreign Application Priority Data
Feb. 28, 2014 (JP) 2014-039292

(51) Int. Cl. G02B 6/38

(52) U.S. Cl. CPC G02B 6/3881

(57) ABSTRACT

An optical connector ferrule having a front end, a rear end, an upper surface, and a lower surface includes a window opening on the upper surface, a plurality of fiber holes passing through a portion between the front end and the window along a first direction and including small diameter portions on the front end side and large diameter portions on the window side, and fiber grooves extending from the large diameter portions along the first direction and having openings in a third direction, in which the width of the opening is smaller than the diameter of the large diameter portion, and the depth of the fiber groove is smaller than the radius of the large diameter portion.

### BACKGROUND OF THE INVENTION

1. Field of the Invention

The present invention relates to an optical connector ferrule.

2. Related Background Art

Japanese Patent No. 4200900 discloses a mold for producing an optical connector ferrule. In the mold, an intermediate mold having pins for forming plural fiber holes is disposed between an upper mold and a lower mold. An optical connector ferrule having plural fiber holes can be obtained by injecting a resin into the mold and solidifying the resin.

### SUMMARY

When an optical connector ferrule is produced using a mold in which pins are arranged inside as described above, the pins are sometimes inclined in a step of solidifying a resin. In this case, the fiber holes of the optical connector ferrule may also be inclined. FIG. 18 shows a mold for producing the optical connector ferrule 100. A center axis C1 of the fiber hole 102 is inclined with respect to a normal direction of an end surface 100a.

The end surface 100a is sometimes polished so as to be inclined at a predetermined angle (for example, 8°). However, when the fiber holes 102 are inclined, the opening positions of the fiber holes 102 on the end surface 100a are shifted by polishing.

An optical connector ferrule according to the present invention includes a front end, a rear end, an upper surface, and a lower surface, and the optical connector ferrule comprises a window opening on the upper surface, a plurality of fiber holes passing through a portion between the front end and the window along a first direction and each fiber hole including a small diameter portion on the front end side and a large diameter portion on the window side, and a plurality of fiber grooves extending from each of the large diameter portions along the first direction and each fiber groove having an opening in a second direction perpendicular to the first direction, in which the width of the opening is smaller than the diameter of the large diameter portion, and the depth of the fiber groove is smaller than the radius of the large diameter portion.

### BRIEF DESCRIPTION OF THE DRAWINGS

FIG. 1 shows an optical connector ferrule according to an embodiment.

FIG. 2 is a cross-sectional view taken along line II-II of the optical connector ferrule shown in FIG. 1.

FIG. 3 shows a mold for producing the optical connector ferrule shown in FIG. 1.

FIG. 4 is a cross-sectional view taken along the XZ plane of the mold shown in FIG. 3.

FIG. 5 shows an intermediate mold of the mold shown in FIG. 3.

FIG. 6 is an enlarged view of a protrusion of the mold shown in FIG. 3.

FIG. 7 is a cross-sectional view taken along the XZ plane for explaining a fiber hole of the optical connector ferrule shown in FIG. 1 and a groove of the mold for producing the optical connector ferrule.

FIG. 8 shows a groove of a mold according to a comparative example.

FIG. 9 is a cross-sectional view taken along the XZ plane for explaining the flow of resin in a cavity of the mold.

FIG. 10 is a cross-sectional view taken along the XZ plane for explaining the bending of fiber hole pins of the mold.

FIGS. 11A to 11C show modification examples of the optical connector ferrule and the mold.

FIGS. 12A to 12C show a modification example of the mold.

FIGS. 13A to 13C show a modification example of the mold.

FIGS. 14A to 14C show a modification example of the mold.

FIGS. 15A to 15C show a modification example of the optical connector ferrule.

FIGS. 16A to 16C show a modification example of the optical connector ferrule.

FIGS. 17A to 17C show a modification example of the optical connector ferrule.

FIG. 18 shows fiber holes near an end surface of the optical connector ferrule.

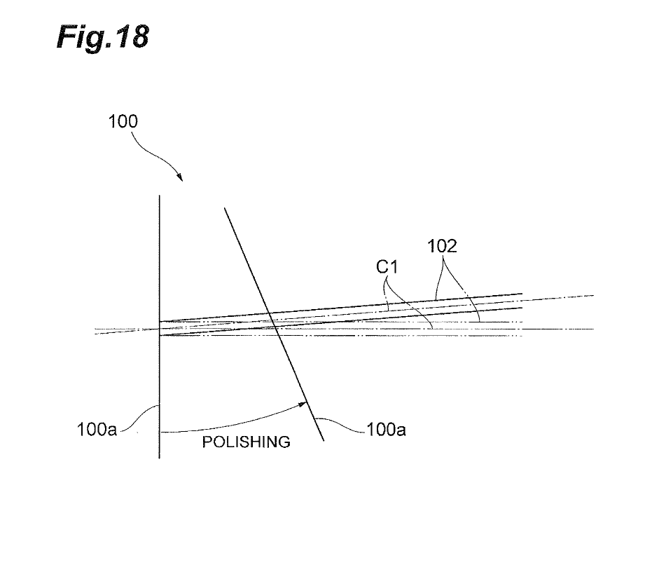

### DESCRIPTION OF THE EMBODIMENTS

Specific examples of a method of producing an optical connector ferrule, an optical connector ferrule, and a mold for producing an optical connector ferrule according to an embodiment will be described with the accompanying drawings. The present invention is not limited to these examples and it is intended that the scope of the invention be defined by the scope of the claims and include all modifications within the equivalent meaning and scope of the claims. In the following description, the same reference numerals denote the same parts throughout the drawings, and a repeated explanation will be omitted.

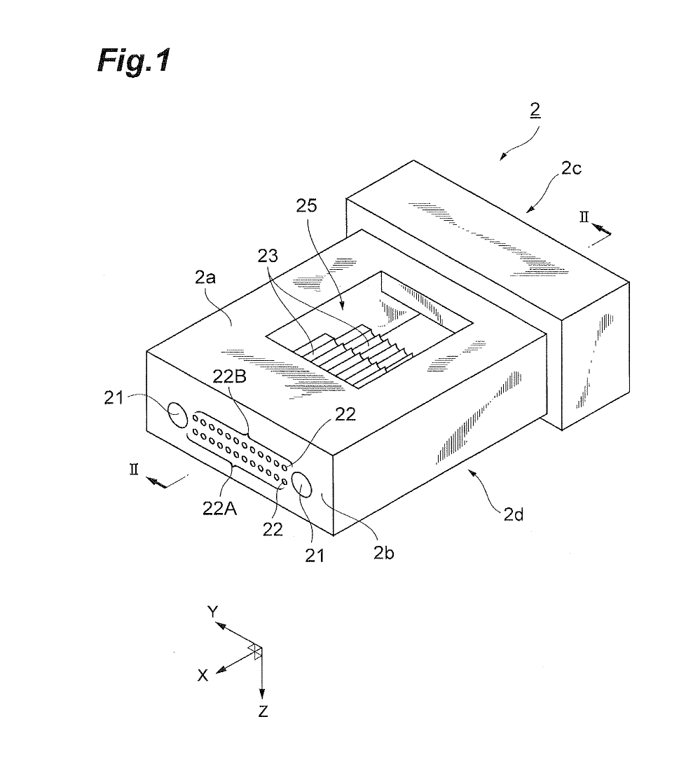

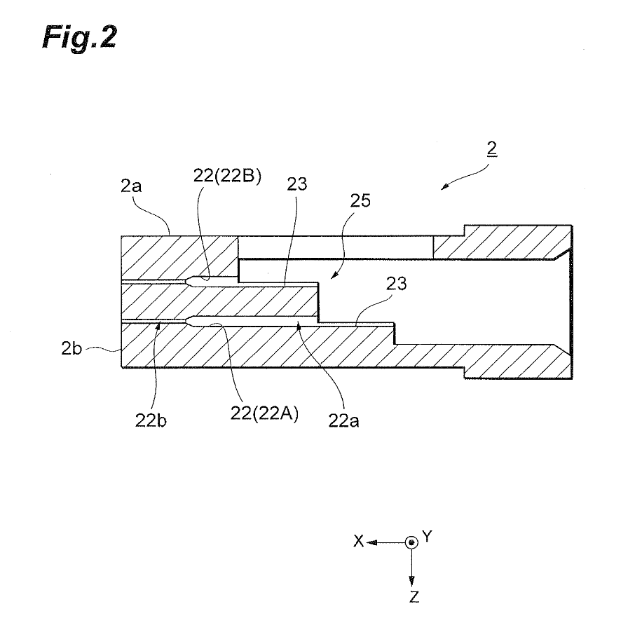

FIG. 1 shows an optical connector ferrule according to an embodiment. FIG. 2 is a cross-sectional view taken along line II-II of the optical connector ferrule shown in FIG. 1. To facilitate the comprehension of the explanation, an XYZ orthogonal coordinate system is shown in the drawings. An X-axis represents a first direction which is a longitudinal direction of the optical connector ferrule, a Z-axis represents a second direction which is a height direction of the optical connector ferrule, and a Y-axis represents a third direction which is a width direction of the optical connector ferrule.

As shown in FIGS. 1 and 2, an optical connector ferrule 2 has a front end 2b, a rear end 2c, an upper surface 2a, and a lower surface 2d. The upper surface 2a extends along the XY plane. The front end 2b extends along the YZ plane and contacts with another optical connector ferrule to be connected. The optical connector ferrule 2 has two guide holes 21 into which guide pins are inserted, and a plurality of fiber holes 22 (24 holes in the embodiment) which are disposed between the two guide holes 21. The two guide holes 21 and the plural fiber holes 22 extend along the X-axis direction from the front end 2b side to the rear end 2c side of the optical connector ferrule 2, and open to the front end 2b. Each fiber hole 22 includes a large diameter portion 22a on a window 25 side, and a small diameter portion 22b on the front end 2b side. A plurality of fiber groves 23 are provided in the rear end side of the fiber hole 22. The fiber groove 23 extends along the X direction from the large diameter portion 22a of the fiber hole 22. The window 25 is formed on the upper surface 2a and passes through the fiber hole 22 and the rear end 2c. The fiber hole 22 passes through a portion between the front end 2b and the window 25. An optical fiber is inserted from the rear end 2c, guided by the fiber groove 23, inserted into the fiber hole 22, and fixed by an adhesive injected from the window 25.

The plural fiber holes 22 constitute a first fiber hole row 22A on the lower surface 2d side and a second fiber hole row 22B on the side close to the upper surface 2a. The first fiber hole row 22A and the second fiber hole row 22B include the plural fiber holes 22 arranged in the Y direction.

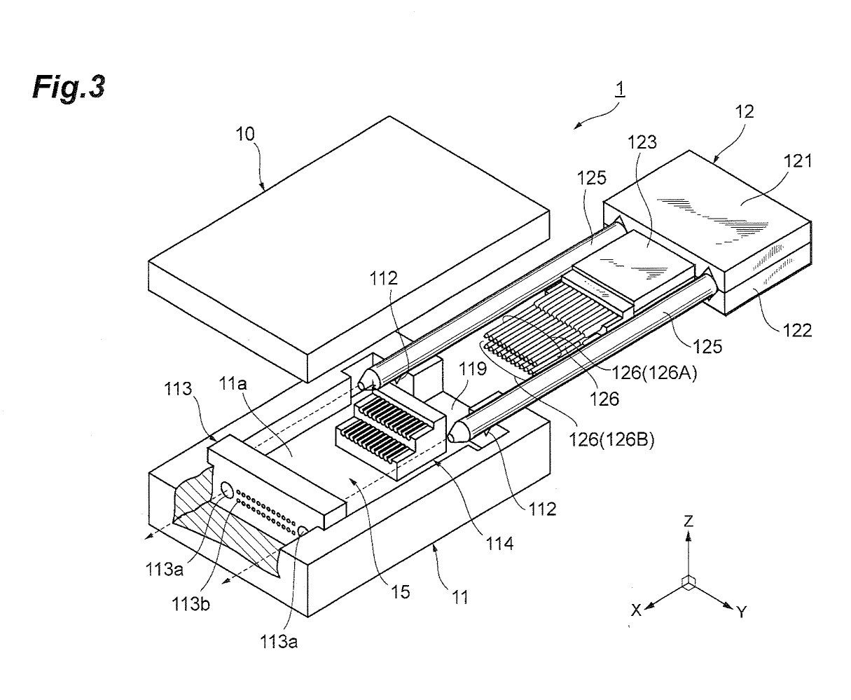

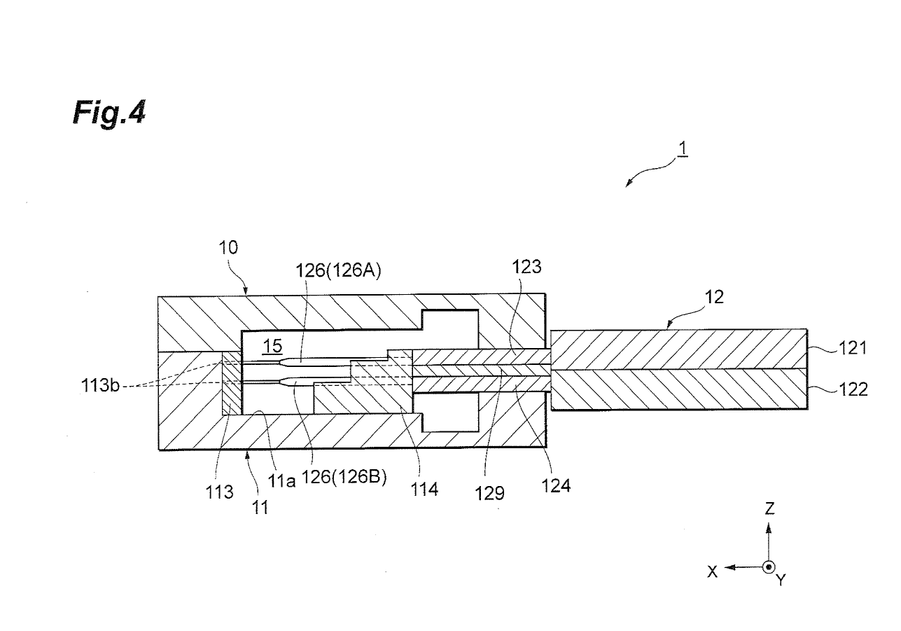

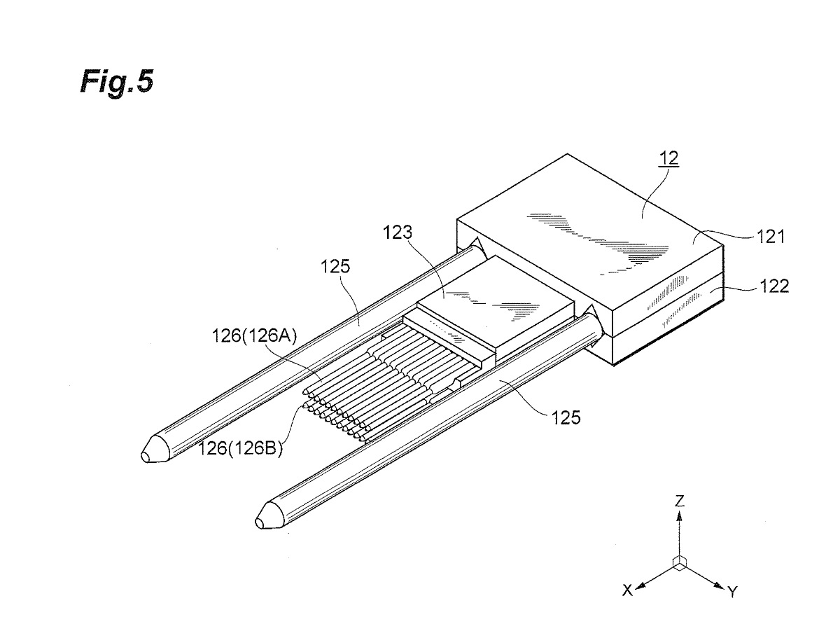

FIGS. 3, 4, and 5 show a mold used for producing the optical connector ferrule 2. FIG. 3 is an exploded perspective view of a mold 1. FIG. 4 is a cross-sectional view taken along the XY plane of the mold 1. FIG. 5 is a perspective view showing an intermediate mold 12 of the mold 1.

The mold 1 includes an upper mold 10 (first mold), a lower mold 11 (second mold), and an intermediate mold 12. The upper mold 10 and the lower mold 11 define a cavity 15 and the intermediate mold 12 is disposed in the cavity 15. The lower mold 11 has a bottom surface 11a which defines the cavity 15. The intermediate mold 12 includes two guide hole pins 125 for forming the guide holes 21 of the optical connector ferrule 2. Plural fiber hole pins 126 for forming the fiber holes 22 of the optical connector ferrule 2 are disposed between the two guide hole pins 125. The rear ends of the guide hole pins 125 and the fiber hole pins 126 are held by a pair of holding members 121 and 122. The rear end of the fiber hole pins 126 is further held by an upper holding member 123, a lower holding member 124, and a spacer 129 which are thinner than the holding members 121 and 122. The upper holding member 123, the lower holding member 124, and the spacer 129 are held by the holding members 121 and 122. The holding members 121 and 122 are fixed to each other by screwing.

The plural fiber hole pins 126 forms a first pin row 126A and a second pin row 126B. The first pin row 126A and the second pin row 126B include the plural fiber hole pins 126 arranged in the Y direction. The first pin row 126A forms the first fiber hole row 22A and the second pin row 126B forms the second fiber hole row 22B in the optical connector ferrule 2.

At the rear end of the lower mold 11, two V-grooves 112 for positioning the respective two guide hole pins 125 are formed. A recess 119 for housing the upper holding member 123, the lower holding member 124, and the spacer 129 is formed between the two V-grooves 112. A pin holding member 113 is disposed at the tip end of the lower mold 11. Two insertion holes 113a for fixing the respective tip ends of the two guide hole pines 125, and insertion holes 113b for fixing the respective tip ends of the fiber hole pins 126 are formed in the pin holding member 113.

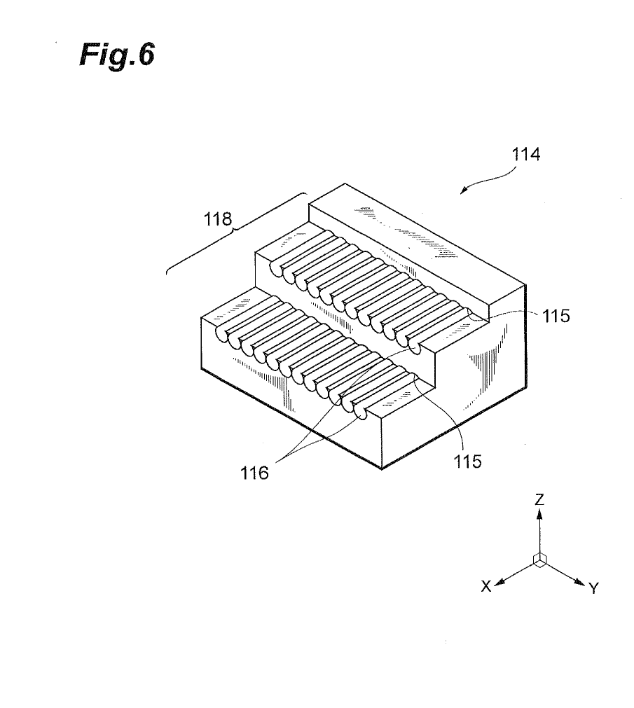

A protrusion 114 for forming the window 25 of the optical connector ferrule 2 is provided at the center of the bottom surface 11a of the lower mold 11. As shown in FIG. 6, the protrusion 114 includes insertion holes 115 for accommodating the respective rear ends of the fiber hole pins 126. A stepped portion 118 is formed at the tip end side of the upper end of the protrusion 114. In the stepped portion 118, the tip end side of the insertion hole 115 is formed into a C-shaped groove 116 and the upper portion (Z direction) is opened.

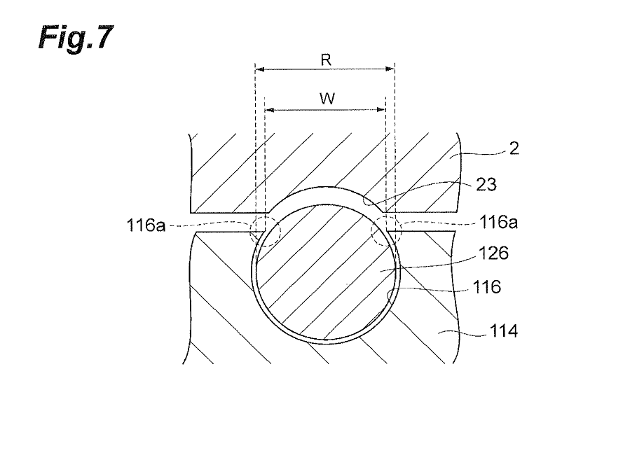

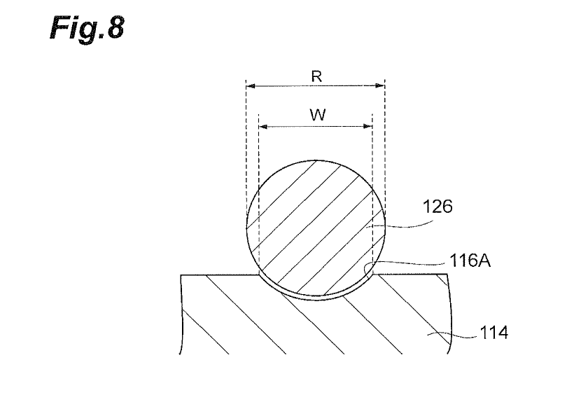

FIG. 7 shows the C-shaped groove 116 of the mold 1 and the groove 23 of the optical connector ferrule 2. FIG. 8 shows a mold as a comparative example and a groove 116A formed on the tip end side of the insertion hole 115 in the stepped portion 118.

As shown in FIGS. 6, 7, and 8, the opening of the C-shaped groove 116 has a width W in the Y direction. The width W is smaller than the diameter R of the fiber hole pin 126.

The groove 116A of the mold shown in FIG. 8 covers a range of half or less of the circumference of the fiber hole pin 126. The C-shaped groove 116 shown in FIG. 7 covers a range wider than half of the circumference of the fiber hole pin 126.

A method of producing the optical connector ferrule 2 using the mold 1 will be described. First, the guide hole pins 125 and the fiber hole pins 126 are held by the holding members 121 and 122 to form the intermediate mold 12. Then, the guide hole pins 125 are inserted into the insertion holes 113a of the pin holding member 113, the fiber hole pins 126 are further inserted into the insertion holes 115 of the protrusion 114 and the insertion holes 113b of the pin holding member 113, and the intermediate mold 12 is fixed to the lower mold 11. The upper mold 10 and the lower mold 11 are assembled to form the cavity 15.

A resin (for example, polyphenylene sulfide) is injected into the cavity 15 and solidified. Then, the intermediate mold 12 is pulled out and the upper mold 10 and the lower mold 11 are opened, whereby the optical connector ferrule 2 is obtained.

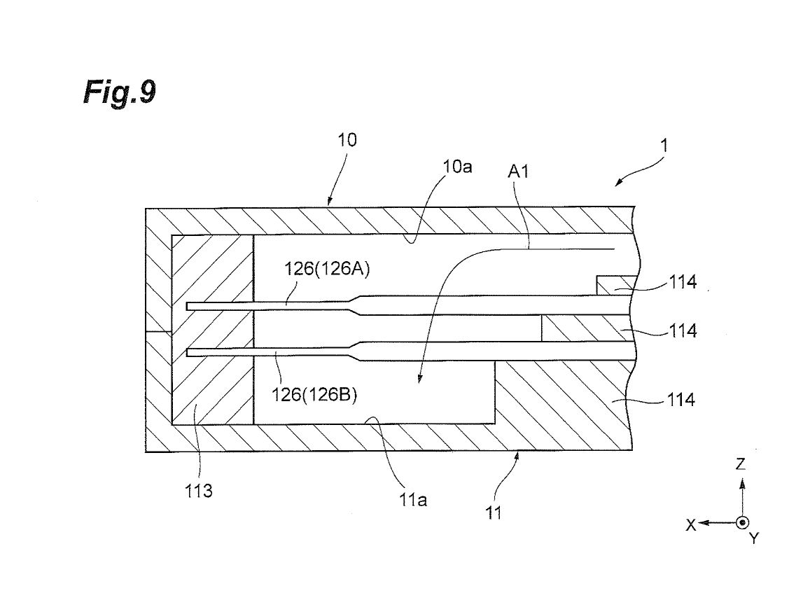

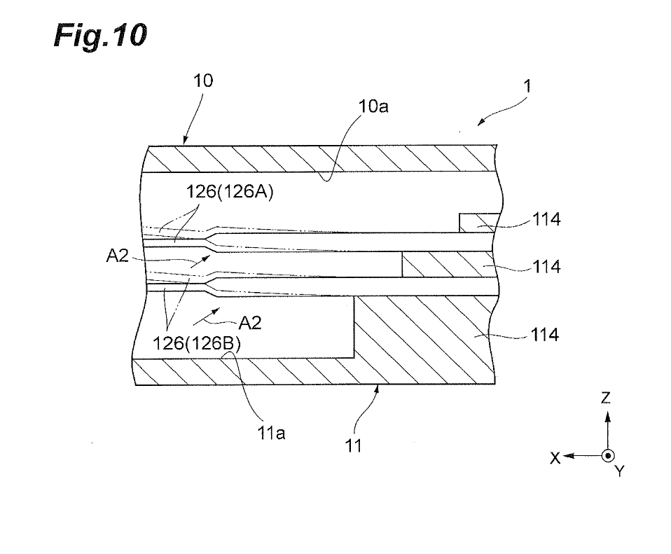

The flow of the resin injected into the cavity 115 will be described. FIG. 9 is a cross-sectional view taken along the XY plane of the mold 1 and FIG. 10 is an enlarged view thereof. Since the resin injected into the cavity 115 flows along the bottom surface 11a of the lower mold 11 and is interrupted by the protrusion 114, the flow of the resin along the bottom surface 11a is slower than the flow of the resin along a surface 10a of the upper mold 10 which is opposite to the bottom surface 11a. As a result, the resin flows from the surface 10a to the fiber hole pins 126 as indicated by the arrow A1. Due to the flow of the resin, the fiber hole pins 126 are bent as shown in FIG. 10.

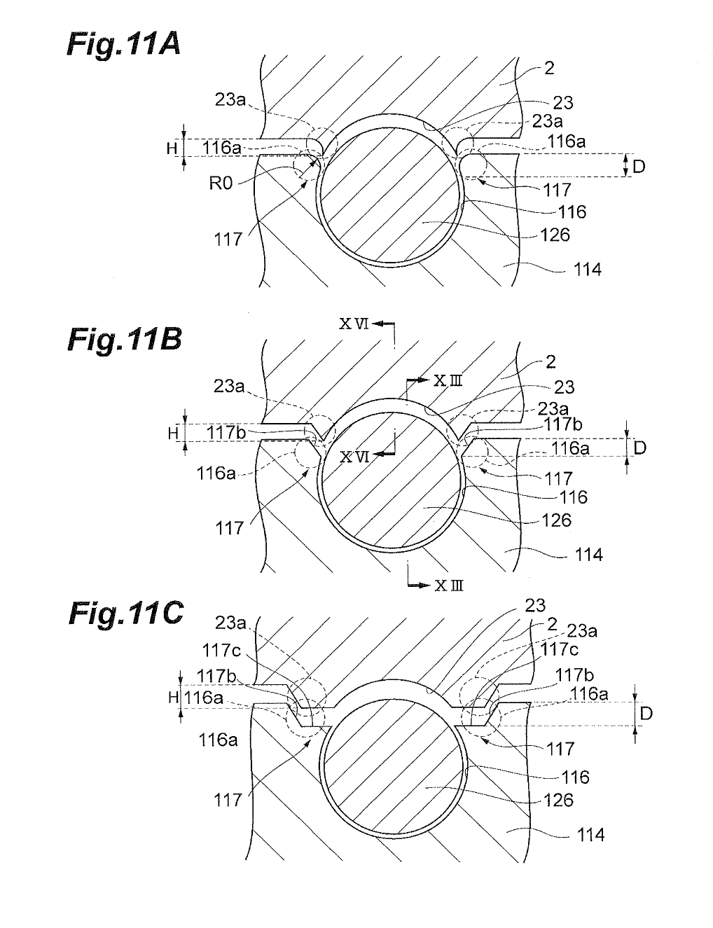

FIGS. 11A to 11C are cross-sectional views taken along the YZ plane of modifications of the C-shaped groove 116 of the mold 1 (the protrusion 114). The C-shaped groove 116 shown in FIG. 11A has enlarged portions 11 at both ends 1 16a of opening in the cross section taken along the YZ plane. The enlarged portion 117 may have a curvature R0. The curvature R0 is, for example, 5 μm to 30 μm. The C-shaped groove 116 shown in FIG. 11B has enlarged portions 117 formed by flat surfaces 117b at the both ends 116a of opening. The C-shaped groove 116 shown in FIG. 11C has enlarged portions 117 formed by plural flat surfaces 117b and 117c having different angles from each other with respect to the Y direction at the both ends 116a. The optical connector ferrule 2 produced by using the mold 1 having such a C-shaped groove 116 has protruding portions 23a at both ends of the opening of the fiber groove 23 in the cross section taken along the YZ plane. When an optical fiber is inserted into the fiber hole 22, the protruding portion 23a prevents the optical fiber from being shifted from the fiber groove 23.

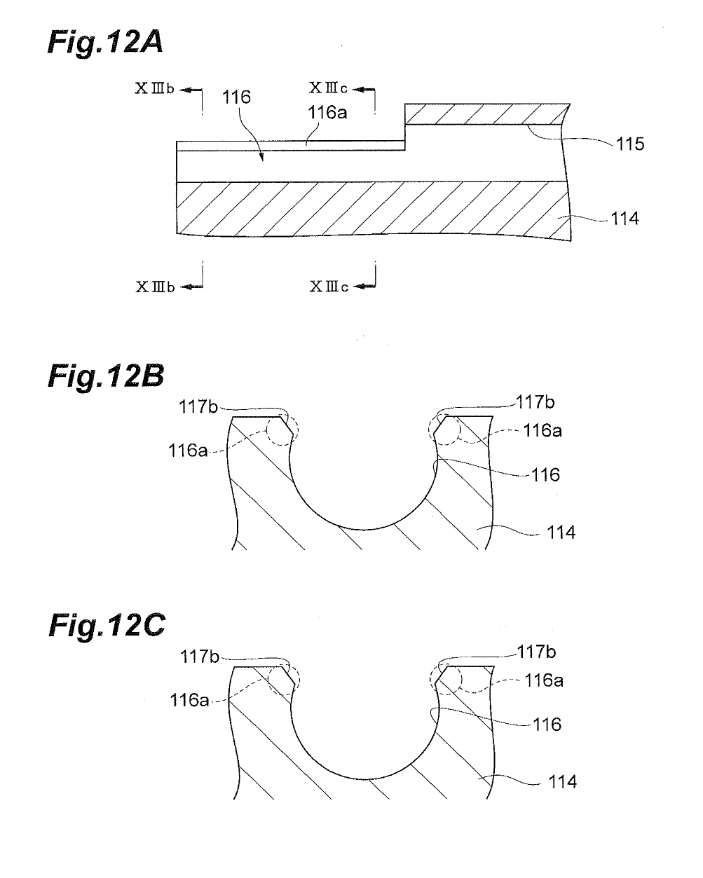

FIG. 12A shows a cross section of the C-shaped groove 116 according to an example of the mold 1 shown in FIG. 11B taken along line XIII-XIII (cross section taken along the XZ plane). FIG. 12B shows a cross section taken along line XIIIb-XIIIb (cross section taken along the YZ plane) shown in FIG. 12A. FIG. 12C shows a cross section taken along line XIIIc-XIIIc (cross section taken along the YZ plane) shown in FIG. 12A. The depth D of the enlarged portion 117 is substantially constant from the side close to the insertion hole 115 to the opposite side. In this case, it is possible to prevent the position of the fiber hole pin 126 from being shifted when the optical connector ferrule 2 is produced.

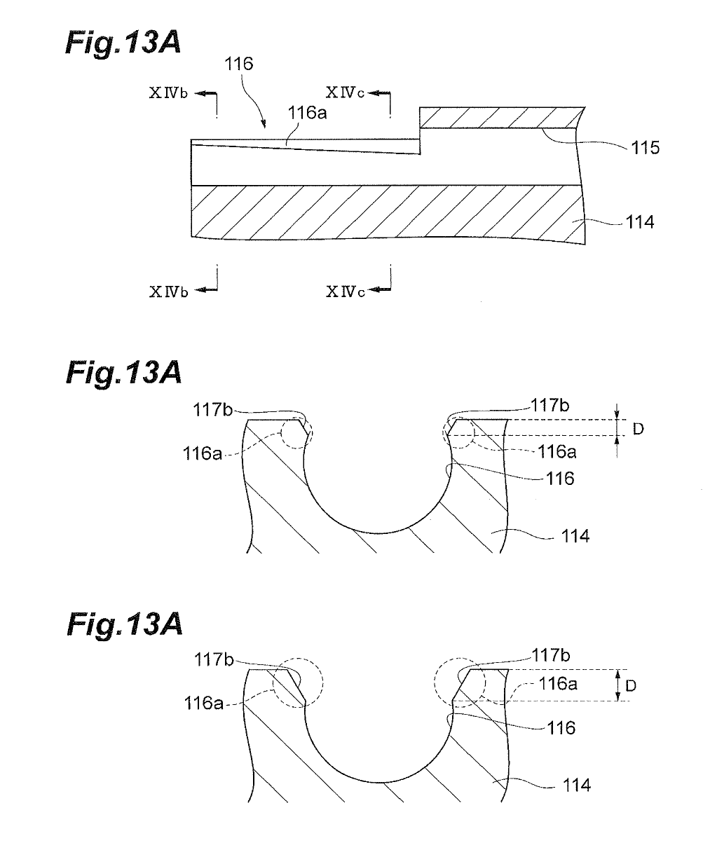

FIG. 13A shows a cross section of the C-shaped groove 116 according to another example of the mold 1 shown in FIG. 11B taken along line XIII-XIII (cross section taken along the XZ plane). FIG. 13B shows a cross section taken along line XIVb-XIVb (cross section taken along the YZ plane) shown in FIG. 13A. FIG. 13C shows a cross section taken along line XIVc-XIVc (cross section taken along the YZ plane) shown in FIG. 13A. The depth D of the enlarged portion 117 is larger on the side close to the insertion hole 115 than on the opposite side of the insertion hole 115.

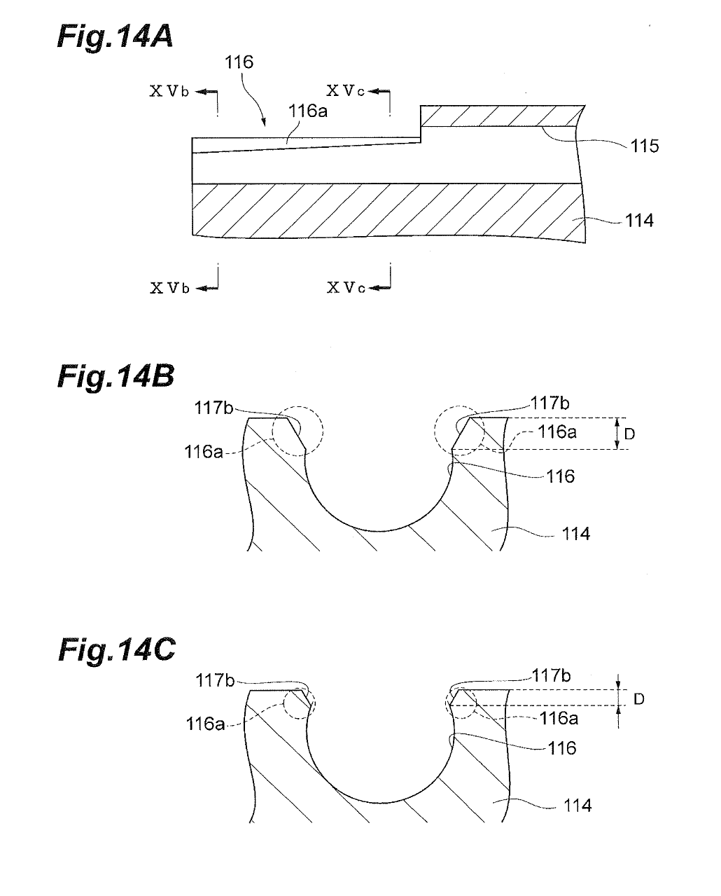

FIG. 14A shows a cross section of the C-shaped groove 116 according to still another example of the mold 1 shown in FIG. 11B taken along line XIII-XIII (cross section taken along the XZ plane). FIG. 14B shows a cross section taken along line XVb-XVb (cross section taken along the YZ plane) shown in FIG. 14A. FIG. 14C shows a cross section taken along line XVc-XVc (cross section taken along the YZ plane) shown in FIG. 14A. The depth D of the enlarged portion 117 is larger on the opposite side of the insertion hole 115 than the side close to the insertion hole 115.

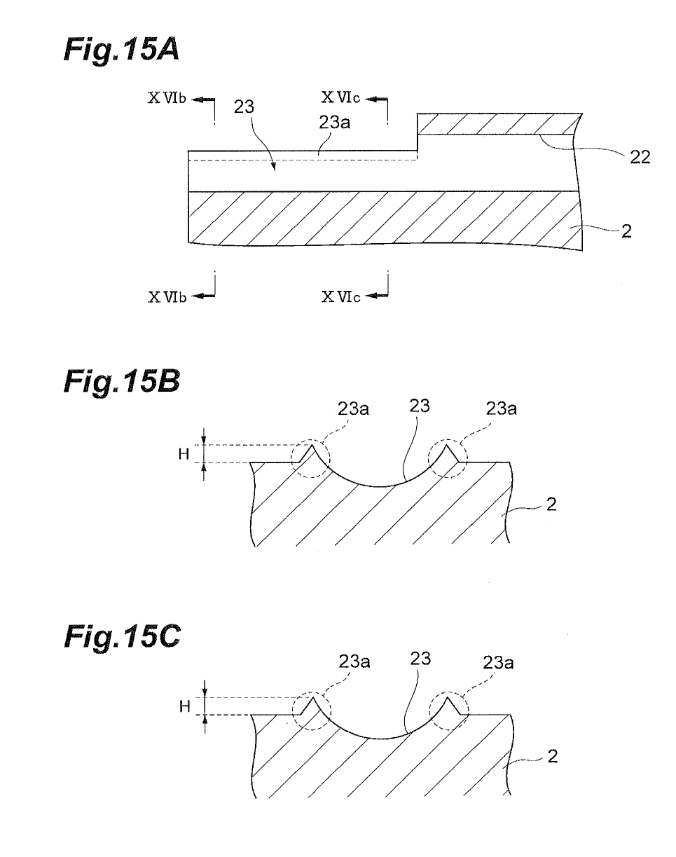

FIG. 15A is a cross sectional view taken along the XZ plane of the fiber groove 23 of the optical connector ferrule 2 produced by using the mold 1 shown in FIGS. 12A to 12C. FIG. 15B shows a cross section taken along line XVIb-XVIb (cross section taken along the YZ plane) shown in FIG. 15A. FIG. 15C shows a cross section taken along line XVIc-XVIc (cross section taken along the YZ plane) shown in FIG. 15A. The height H defined by the protruding portion 23a is substantially constant from the side close to the large diameter portion 22a of the fiber hole 22 with respect to the opposite side.

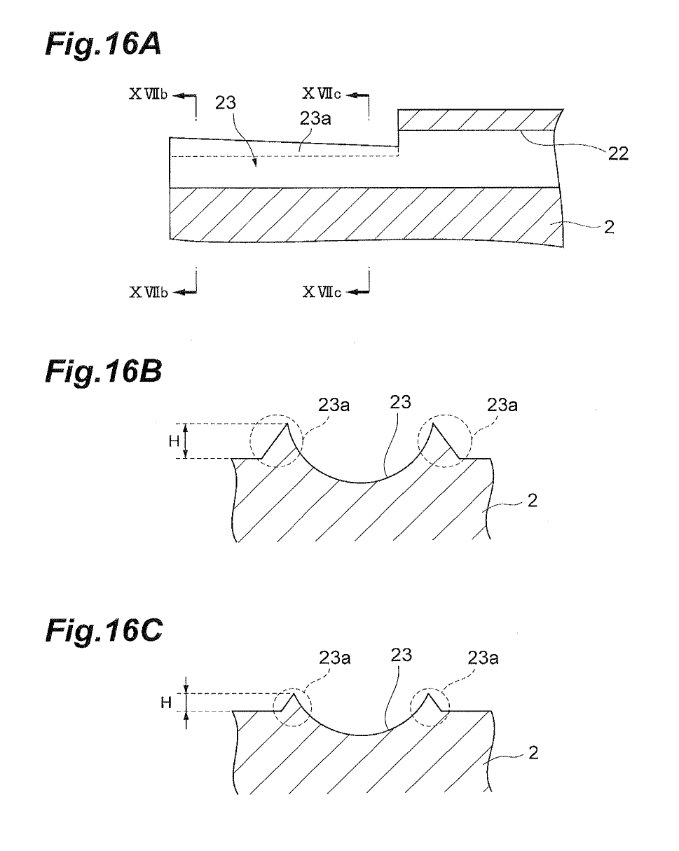

FIG. 16A is a cross-sectional view taken along the XZ plane of the groove 23 of the optical connector ferrule 2 produced by using the mold 1 shown in FIGS. 14A to 14C. FIG. 16B shows a cross section taken along the lime XVIIb-XVIIb (cross section taken along the YZ plane) shown in FIG. 16A. FIG. 16C shows a cross section taken along line XVIIc-XVIIc (cross section taken along the YZ plane) shown in FIG. 16A. The height H defined by the protruding portion 23 a is larger on the opposite side of the large diameter portion 22a of the fiber hole 22 with respect to the side close to the large diameter portion 22a of the fiber hole 22. Thus, when an optical fiber is inserted into the fiber hole 22, the optical fiber is not likely to be shifted from the fiber groove 23 over the entire length.

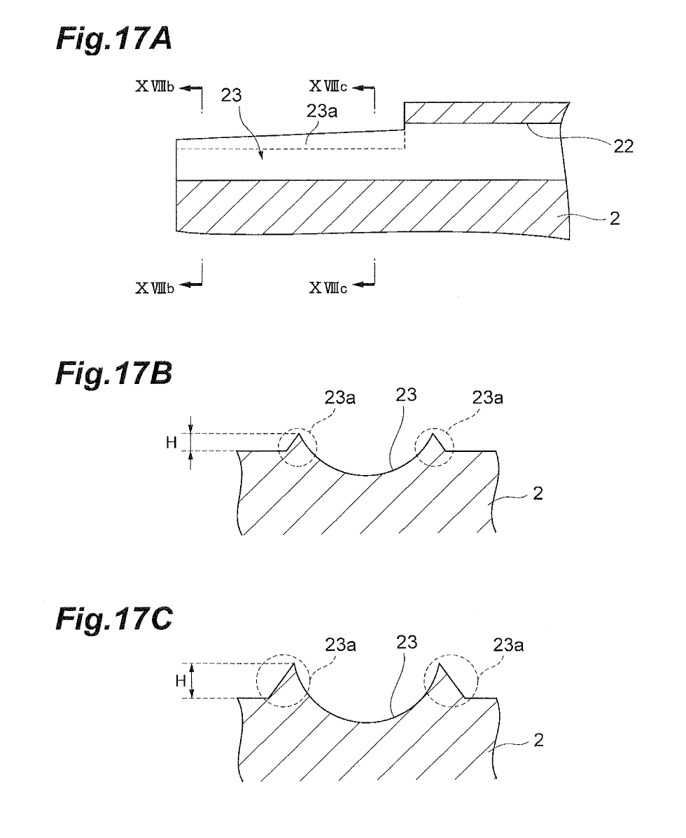

FIG. 17A is a cross-sectional view taken along the XZ plane of the fiber groove 23 of the optical connector ferrule 2 produced by using the mold 1 shown in FIGS. 13A to 13C. FIG. 17B shows a cross section taken along line XVIIIb-XVIIIb (cross section taken along the YZ plane) shown in FIG. 17A. FIG. 17C shows a cross section taken along line XVIIIc-XVIIIc (cross section taken along the YZ plane) shown in FIG. 17A. The height H defined by the protruding portion 23a is larger on the side close to the large diameter portion 22a of the fiber hole 22 with respect to the opposite side. Thus, an optical fiber is not likely to be shifted from the fiber groove 23 near the fiber hole 22, and the optical fiber can be easily inserted into the fiber hole 22.

What is claimed is:

1. An optical connector ferrule which has a front end, a rear end, an upper surface, and a lower surface, the optical connector ferrule comprising:
a window opening on the upper surface;
a plurality of fiber holes passing through a portion between the front end and the window along a first direction and each fiber hole including a small diameter portion on the front end side and a large diameter portion on the window side; and
a plurality of fiber grooves extending from each of the large diameter portions along the first direction and each fiber groove having an opening in a second direction perpendicular to the first direction,
wherein the width of the opening is smaller than the diameter of the large diameter portion, and
the depth of the fiber groove is smaller than the radius of the large diameter portion.

2. The optical connector ferrule according to claim 1,
wherein the fiber groove has protruding portions at both ends in a third direction perpendicular to the first direction and the second direction, and
the opening is defined by the protruding portions.

3. The optical connector ferrule according to claim 2,
wherein the height of the protruding portion has the largest value at the large diameter portion of the fiber hole.

4. The optical connector ferrule according to claim 2,
wherein the height of the protruding portion has the smallest value at the large diameter portion of the fiber hole.

5. The optical connector ferrule according to claim 2,
wherein the height of the protruding portion is substantially constant from the large diameter portion of the fiber hole along the first direction.

6. The optical connector ferrule according to claim 2,
wherein the outer circumference of the protruding portion has a curved shape.

7. The optical connector ferrule according to claim 2,
wherein the outer circumference of the protruding portion has a shape including a plurality of flat surfaces having different angles from each other with respect to the third direction.
